(19) United States
(12) Patent Application Publication
(10) Pub. No.: US 2005/0134629 A1
(43) Pub. Date: Jun. 23, 2005

(54) Ink jet cleaning wipes

(76) Inventors: Thomas W. Martin, Rochester, NY (US); Martin Finkle, Rochester, NY (US); Donald E. Snyder, Spencerport, NY (US)

Correspondence Address: James W. McKee;Fay, Sharpe, Fagan, Minnich & McKee, LLP, 7th Floor, 1100 Superior Avenue, Cleveland, OH, 44114-2518, US

(21) Appl. No.: 10/988,997

(22) Filed: Nov. 15, 2004

Related U.S. Application Data
(60) Provisional application No. 60/531,200, filed on Dec. 19, 2003.

(51) Int. Cl. B41J 2/165

(52) U.S. Cl. 347/22; 347/28

(57) ABSTRACT

Cleaning wipes for cleaning the print head of an ink catridge wherein the wipe includes a substrate impregnated with a cleaning composition including water, an organic solvent, and a surfactant. The wipe leaves little or no residue on the print head resulting in improved printing performance and does not chemically interact with common print cartridge materials.

### BACKGROUND

The present exemplary embodiment relates to a cleaning wipe which has been impregnated with a liquid cleaning composition. More specifically, the present embodiment relates to an ink jet cleaning wipe which is single or multi layer fabric substrate impregnated with a washing solution for cleaning ink jet heads. Although described with application to the cleaning of ink jet printer heads, it is to be appreciated that the present exemplary embodiment is also amenable to other like applications.

The use of inkjet printing systems has grown dramatically in recent years. This growth may be attributed to substantial improvements in print resolution and overall print quality coupled with appreciable reduction in cost. Today's inkjet printers offer acceptable print quality for many commercial, business, and household applications at costs fully an order of magnitude lower than comparable products available just a few years ago. Notwithstanding their recent success, intensive research and development efforts continue toward improving inkjet print quality, while further lowering cost to the consumer.

Various ink jet recording methods have been developed, including those using thermal and piezoelectric print heads. Thermal inkjet technology employs heat to force ink through the small nozzles in the printhead. When the ink is “boiled”, it expands and forms a bubble, which is ejected from the nozzle in the printhead. Piezoelectric printheads, on the other hand, produce droplets using electromechanical means rather than heat. In a piezoelectric head, a crystal fluctuates according to electrical signals, squirting the ink droplet out of the nozzles.

Although both print heads can produce excellent results, print quality can degrade if the print head nozzles become clogged or dirty. Particularly in thermal print heads in which heat energy is used, foreign substances are apt to deposit on the face plate surface of the head by the action of heat on residual ink. These deposits impair the formation of ink droplet and result in reduced print quality. In particular, the heater in the print head is repeatedly heated to provide for ink ejection. This continuous heating causes decomposition products of the ink to be deposited on the surface of the print head nozzles as well as debris due to evaporation, resulting in a reduction in print quality.

In addition, the use of quick drying ink, which reduces smearing of the ink after deposition, along with small nozzles leaves the print heads susceptible to clogging. These clogs result from not only dried ink, but also from dust, paper fibers, as well as solids (e.g. pigments, etc.) suspended within the ink itself. New pigment based inks also present potential clogging problems. Dispersants in the ink, used to keep pigment particles from flocculating, tend to form a film on the print head. This film attracts and binds paper fibers, dust and other contaminants from both the ink and elsewhere.

It has been recognized that the application of a servicing solvent will help to mitigate the problem of dried ink by redissolving the dried ink as well as removing dust and other contaminants from the print head. Thus, ink jet recording head cleaning cartridges incorporating such solvents have been proposed. However, a need remains for a simple and economical method for cleaning the face plates of a print head using a disposable wipe without compromising the mechanical and/or electrical integrity of the ink jet cartridge.

### BRIEF DESCRIPTION

In one embodiment, there is provided a cleaning wipe for cleaning the print head of a ink cartridge, the wipe including a water insoluble substrate and a cleaning solution, wherein the cleaning solution includes water, an aqueous organic solvent, and a surfactant, wherein the wipe is impregnated with the cleaning solution.

In a second embodiment, there is provided a process for making a cleaning wipe for cleaning the print head of a ink cartridge, the process comprising the steps of: providing a water insoluble substrate; providing a cleaning solution comprising water, an organic solvent, and a surfactant; and impregnating the substrate with the cleaning solution.

### DETAILED DESCRIPTION

The disclosed embodiments provide a cleaning wipe impregnated with a liquid cleaner for cleaning and removing debris from an ink jet cartridge print head.

The substrate for the wipe is generally an absorbent or adsorbent material. A wide variety of materials may be used for the substrate. It should have sufficient wet strength, non-abrasivity, loft and porosity. Examples include non-woven substrates, woven substrates, hydroentangled substrates and sponges.

Preferably, the substrate is a non-woven sheet, which is at least one layer, made of wood pulp, a synthetic fiber, or a blend of wood pulp and a synthetic fiber, without limitation, such as polyester, rayon, nylon, polypropylene, polyethylene, and other cellulose polymers. Non-woven materials may include non-woven fibrous sheet materials which include meltblown, coform, air-laid, spun bond, wet laid, bonded-carded web materials, hydroentangled (also known as spunlaced) materials, and combinations thereof. These materials can comprise synthetic or natural fibers or combinations thereof. One suitable material is polypropylene. A binder may or may not be present. Manufacturers of suitable substrate materials include Kimberly-Clark, E.I. du Pont de Nemours and Company, Dexter, American Nonwovens, James River, BBA Nonwovens and PGI.

Woven materials, such as cotton fibers, cotton/nylon blends, or other textiles may also be used herein. Regenerated cellulose, polyurethane foams, and the like, which are used in making sponges, may also be suitable for use herein.

The substrate's liquid loading capacity should be at least about 50%-1000% of the dry weight thereof, most preferably at least about 200%-800%. The substrate is typically is produced as a sheet or web which is cut, die-cut, or otherwise sized into the appropriate shape and size. Likewise, the wipes will preferably have a certain wet tensile strength which is preferably about 25 to about 250 Newtons/m, more preferably about 75-170 Newtons/m.

The substrates, which are now referred to simply as wipes, can be individually sealed with a heat-sealable or glueable thermoplastic overwrap (such as polyethylene, Mylar, and the like). More preferably the wipes can be packaged as numerous, individual sheets which are then impregnated or contacted with the liquid cleaning ingredients of the invention for more economical dispensing. Even more preferably, the wipes can be formed as a continuous web during the manufacturing process and loaded into a dispenser, such as a canister with a closure, or a tub with closure. The closure is to seal the moist wipes from the external environment and to prevent premature volatilization of the liquid ingredients. Without limitation, the dispenser may be formed of plastic, such as high density polyethylene, polypropylene, polycarbonate, polyethylene terephthalate (PET), polyvinyl chloride (PVC), or other rigid plastics.

The continuous web of wipes could preferably be threaded through a thin opening in the top of the dispenser, most preferably, through the closure. A means of sizing the desired length or size of the wipe from the web would then be needed. A knife blade, serrated edge, or other means of cutting the web to desired size can be provided on the top of the dispenser, for non-limiting example, with the thin opening actually doubling in duty as a cutting edge. Alternatively, the continuous web of wipes could be scored, folded, segmented, or partially cut into uniform or non-uniform sizes or lengths, which would then obviate the need for a sharp cutting edge. Further, as in hand tissues, the wipes could be interleaved, so that the removal of one wipe advances the next, and so forth.

The bottom and top layers may have different textures and abrasiveness. Differing textures can result from the use of different combinations of materials or from the use of different manufacturing processes or a combination thereof. A dual texture substrate can be made to provide the advantage of a more abrasive side for cleaning difficult to remove soils. A softer side can be used for more delicate or less soiled surfaces. The substrate should not dissolve or break apart in water.

The cleaning solution of the present embodiments includes water, an aqueous organic solvent and a surfactant.

The aqueous organic solvent in the cleaning solution aids in the removal of debris from the face plate as well as prevents the cleaning solution from prematurely drying. An aqueous organic solvent with low viscosity is preferable because it aids the penetration of the washing solution into the ink jet head.

Specific examples of the aqueous organic solvent include, but are not limited to, polyvalent alcohols and polyalkylene glycols such as ethylene glycol, diethylene glycol, triethylene glycol, polyethylene glycol, propylene glycol, 1,5-pentane diol, glycerin, and thiodiglycol; glycol ethers such as ethylene glycol monomethyl ether, ethylene glycol monobutyl ether, diethylene glycol monoethyl ether, diethylene glycol monobutyl ether, triethylene glycol monobutyl ether, and propylene glycol monomethyl ether; pyrrolidone, N-methyl-2-pyrrolidone, dimethylsulfoxide, sulfolane; as well as alcohols such as ethanol, isopropanol, butanol, and benzyl alcohol; and alkanolamines such as monoethanolamine, diethanolamine, and triethanolamine, and the like.

Among these compounds, glycol ethers are preferable since they have comparatively low viscosity and are effective in improving the penetrability so that the washing solution can be widely spread over the inside of the print head in an efficient manner. A preferred aqueous organic solvent for use in the present embodiments includes a blend of diethylene glycol, diethylene glycol monobutyl ether and triethanolamine. The amount of aqueous organic solvent may be up to about 25% by weight of the cleaning solution, but is preferably from about 2 to about 15% by weight.

Suitable surfactants include nonionic surfactants, anionic surfactants, cationic surfactants, and amphoteric surfactants. Among these, nonionic surfactants are preferable as they suppress the increase in the electroconductivity of the washing solution.

Preferred nonionic surfactants include non-foaming acetylene glycol derivatives including ethylene oxide adducts of acetylene glycol. Such compounds are available under the name SURFYNOL® from Air Products and Chemicals, Inc. A particularly preferred compound is an ethylene oxide adduct of ethylene glycol having a ethylene oxide content of 65% by weight, available under the name SURFYNOL® 465 and having the following formula wherein m+n=10. These surfactants are exceptional wetting agents as well as strong defoamers, making them particularly suited for use in the present embodiments.

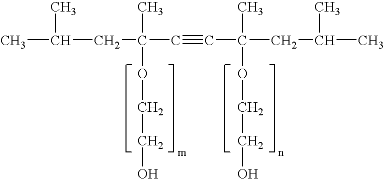

Specific examples of other suitable nonionic surfactants include polyoxyethylenealkyl phenyl ethers such as polyoxyethylenenonyl phenyl ether, polyoxyethyleneoctyl phenyl ether, and polyoxyethylenedodecyl phenyl ether; polyoxyethylenealkyl ethers, polyoxyethylene fatty acid esters, sorbitan fatty acid esters, polyoxyethylene/polyoxypropylene block copolymers, ethylene oxide adducts of glycerin, polyoxyethylenesorbitan fatty acid esters, and fatty acid alkylolamides.

The amount of surfactant in the cleaning solution may vary from about 0.1 to 5% by weight, preferably about 0.5 to 2.5%.

The principal ingredient in the cleaning solution is water, which should be present at a level of at least about 70%, more preferably at least about 80%, and most preferably, at least about 90%. Distilled, deionized, or industrial soft water is preferred so as not to contribute to formation of a residue and to avoid the introduction of undesirable metal ions.

Two examples of preferred formulations are presented in Table 1. Formula 2 was found to be preferred as it left little or no residue while providing comparable or superior cleaning results. The amount of each component is in weight percent.

TABLE 1

| Component | Formula 1 | Formula 2 |
|---|---|---|
| Water | 77.0 | 91.7 |
| Diethylene glycol | 10.0 | 5.0 |
| Diethylene glycol monobutyl | 10.0 | 2.0 |
| ether | | |
| Triethanolamine | 1.0 | 0.5 |
| Surfynol 465 | 2.0 | 0.8 |

In practice, the liquid cleaner is impregnated, dosed, loaded, metered, or otherwise dispensed onto the wipe. This can be executed in numerous ways. For example, each individual wipe could be treated with a discrete amount of liquid cleaner. More preferably, a mass treatment of a continuous web of wipes with the liquid cleaner will ensue. In some cases, an entire web of wipes could be soaked in the cleaner. In other cases, while the web is being spooled, or even during the creation of the nonwoven material, the liquid cleaner could be sprayed or otherwise metered onto the web. A mass, such as a stack of individually cut and sized wipes could also be impregnated in its container by the manufacturer, or by the user.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A cleaning wipe for cleaning the print head of a ink cartridge, said wipe comprising a water insoluble substrate and a cleaning solution, wherein said cleaning solution comprises water, an aqueous organic solvent, and a surfactant, wherein said wipe is impregnated with said cleaning solution.

2. A cleaning wipe according to claim 1, wherein said water comprises distilled, deionized, or industrial soft water.

3. A cleaning wipe according to claim 1, wherein said aqueous organic solvent comprises at least one of an alcohol, a glycol, a glycol ether, an alkonolamine, pyrrolidone, or blends thereof.

4. A cleaning wipe according to claim 1, wherein said aqueous organic solvent comprises a blend of diethylene glycol, diethylene glycol monobutyl ether and triethanolamine.

5. A cleaning wipe according to claim 1, wherein said cleaning solution comprises at least about 90% water.

6. A cleaning wipe according to claim 1, wherein said cleaning solution comprises from about 2 to about 15% aqueous organic solvent, about 0.5 to about 2.5% surfactant, and at least about 70% water.

7. A cleaning wipe according to claim 1, wherein said substrate comprises a non-woven sheet comprising synthetic fiber.

8. A cleaning wipe according to claim 1, wherein said substrate comprises a woven sheet.

9. A cleaning wipe according to claim 1, wherein said substrate has a liquid loading capacity that is about 200 to 800% of the dry weight of the sheet.

10. A cleaning wipe according to claim 1, wherein said substrate has a wet tensile strength of from 75 to 175 Newtons/m.

11. A cleaning wipe according to claim 1, wherein said substrate is formed from a continuous web of material which is separated into individual sheets at the time of use.

12. A cleaning wipe according to claim 1, wherein said substrate comprises a bottom and a top layer having different textures and abrasiveness.

13. A cleaning wipe according to claim 1, wherein said surfactant comprises an ethylene oxide adduct of ethylene glycol.

14. A cleaning wipe according to claim 1, wherein said substrate comprises non-woven polypropylene fiber.

15. A process for making a cleaning wipe for cleaning the print head of a ink cartridge, said process comprising the steps of:
a) providing a water insoluble substrate;
b) providing a cleaning solution comprising water, an organic solvent, and a surfactant; and
c) impregnating said substrate with said cleaning solution.

16. A process according to claim 15, wherein said step of providing a cleaning solution comprises providing a blend of water, diethylene glycol, diethylene glycol monobutyl ether, triethanolamine, and an ethylene oxide adduct of ethylene glycol surfactant.

17. A process according to claim 15, wherein said step of providing a water insoluble substrate comprises providing a continuous web of a non-woven material, and further wherein said web is sized into individual sheets after said impregnation.

18. A process according to claim 15, wherein said step of providing said cleaning solution comprises providing a blend of from about 2 to about 15% aqueous organic solvent, about 0.5 to about 2.5% surfactant, and at least about 70% water.
